(19) United States
(12) Patent Application Publication
(10) Pub. No.: US 2009/0234635 A1
(43) Pub. Date: Sep. 17, 2009

(54) Voice Entry Controller operative with one or more Translation Resources

(76) Inventors: Vipul Bhatt, Los Altos, CA (US); Vijayant Palaiya, Sunnyvale, CA (US)

Correspondence Address: JAY CHESAVAGE, 3833 MIDDLEFIELD, PALO ALTO, CA, 94303, US

(21) Appl. No.: 12/431,763

(22) Filed: Apr. 29, 2009

Related U.S. Application Data
(63) Continuation-in-part of application No. 11/824,570, filed on Jun. 29, 2007.

(51) Int. Cl. G06F 17/28; G10L 15/26

(52) U.S. Cl. 704/2; 704/235; 704/E15.043

(57) ABSTRACT

A system for scheduled and instant translations from speech to text has a web server for receiving translation requests and registering translation capabilities, a database for storing the requests and capabilities, a scheduler for issuing connection requests between a requester and a translator, a connection server for handling connections between the requester and translator, the connection server also migrating connections from requestor-server-translator to requestor-translator. The system recognizes request types of scheduled, on-demand, and bulk. A scheduled or on-demand translation request results in one or more verifications of availability, and then a connection is made from the requester to the translation resource. Bulk translations are handled as received speech files that are matched to one or more translation resources with optional capabilities and attributes, and the speech file is sent to the selected translation resource and returned to the system for forwarding to the requester as a text file.

### FIELD OF THE INVENTION

The present invention is related to an automated system for requesting, scheduling, and fulfilling requests for speech to text translation for a variety of translation request types, including same language speech to text transcriptions and cross language speech to text translations, on demand real-time translation requests, scheduled real-time translation requests, and requests for bulk translation of voice files to text.

### BACKGROUND OF THE INVENTION

Much research has been conducted in automated speech to text translation, which is known to be a long-standing artificial intelligence problem. Many of the machine-based translations rely on various algorithms to map human utterances into a text-based version of the utterance or speech phrase. An obvious complicating factor in such automated conversion is the level of artificial intelligence required to achieve satisfactory accuracy while offsetting external factors which may impair accuracy such as regional accents, inaudible words or phrases, and background noise. Conversely, human translation requires scheduling a translation session, and the inconvenience and expense of translator travel from one location to another. Activities which may require scheduled or on-demand translation include travel, foreign and domestic business transactions, legal proceedings, and certain transactions which may require special considerations, such as certified medical transcription or translation.

### Patent Prior Art

U.S. Pat. No. 6,198,808 describes a system for receiving speech, converting the speech to text, and transmitting the text for reception by a subscriber having a messaging device such as a pager.

U.S. Pat. No. 5,724,410 describes a system for converting a speech message to text and sending it to a receiving device if the receiving device does not have spoken text capability.

U.S. Pat. No. 7,103,154 describes a system for receiving a voice message, converting it to text using a voice recognition system, and sending the message as an email or page to a receiving device. Similarly, U.S. Pat. No. 6,954,781 performs the same function where the receiving device is a cellular telephone using the SMS (Short Message System) protocol. Also, U.S. Pat. No. 6,366,651 by Griffith et al performs the same speech to text translation for delivery to a telephone or email user.

U.S. Pat. No. 6,504,910 is a system for communication between a hearing person who is using a standard telephone and a non-hearing person who is using a captioning telephone, whereby an automated speech to text translator receives speech from the standard telephone and translates it to text for use by the captioning telephone, and a text to speech system translates typed responses from the captioning telephone into speech for the standard telephone.

U.S. Pat. No. 5,384,701 describes a system for translation from a first language to a second language using a phrasebook approach. U.S. Pat. No. 6,385,586 performs a similar function using translation from speech to text in a first language followed by text to speech in a second language.

U.S. Pat. No. 6,363,337 describes a system for translation of speech into text, where the speech recognition system utilizes a recognition phrasebook which is limited to a particular subject area.

### SUMMARY OF THE INVENTION

A human translation resource registers capabilities and schedule availability with a schedule server. A user requesting translation from source speech of one language to translation text of another language, or possibly source speech and transcription text in the same language, registers a translation or transcription request. A scheduler maps the translation request to a plurality of previously registered resources, either offering requester selectable options or selecting for the user a particular translation resource. The scheduler optionally verifies the availability of the translation resource and user request prior to the appointment, and at a scheduled time, a connection server 116 makes a point to point connection shown in FIG. 1 130 and 132 to each of the translation requester 102 and translation resource client 108. After establishment of the point to point connections to the connection server 116, the connection server 116 optionally performs a handoff to directly couple the translation requester 102 with the translation resource client 108. Events such as connectivity interruptions, requests for a different translation resource and the like are handled using the original point to point connections from the translation requester and translator resource back to the connection server, which is left open following the handoff, but only serves to handle such out-of-band communications from the requester or translator to the connection server. After the translation session is completed, the user is asked to rate the performance of the translation resource, and this information is added to the database for the translation resource.

In an alternative embodiment to the scheduled request type previously described, the request type may be an “on-demand” translation request, which is serviced by the scheduler for immediate service by instantly verifying with available translation resources, confirming with one of them, and starting the translation session thereafter using two point to point connections from the connection server to each of the requester and the translation resource, optionally augmenting these two connections with a new direct connection between the requester and translation resource.

In another alternative embodiment, called a “bulk translation” request, the user provides an encapsulated speech file to be transcribed, and the speech file is received either by the web server, or by the scheduler of the translation system and saved into a database. The requester makes a bulk translation request accompanied by an attribute type, which may be of the form “lowest price”, “highest quality”, “as soon as possible”, “verified translation/transcription”, “prefer a particular geographic location of the transcriber”, or any of several translation request types based on user needs at request time. The bulk translation request and associated speech file is saved into the database, after which the scheduler matches the request according to capabilities and attributes of a translation resource, after which the speech file is delivered to the selected translation resource. The translation resource delivers the text file to the scheduler, where it is subsequently available for downloading and viewing by the requester.

### BRIEF DESCRIPTION OF THE DRAWINGS

FIG. 1 shows a block diagram for a translation system.

FIG. 2 shows a flowchart for client registration and resource translation registration in a translation system.

FIGS. 3 and 3A show a flowchart for a client translation request in a translation system.

FIG. 4 shows the sequence of operations for a client registration event, a translation resource registration event, a client translation request event, and a current translation event.

FIG. 5 shows the sequence of operations for a bulk translation request.

FIG. 6 shows the translation matrix for a client translation request.

FIG. 7 shows the translation matrix for a translation resource.

FIG. 8 shows detail for a translation resource matrix entry with attributes and capabilities.

FIG. 9 shows a metric computation.

FIG. 10 shows an apparatus with a common set of features suitable for a translation requester or a translation resource.

### DETAILED DESCRIPTION OF THE INVENTION

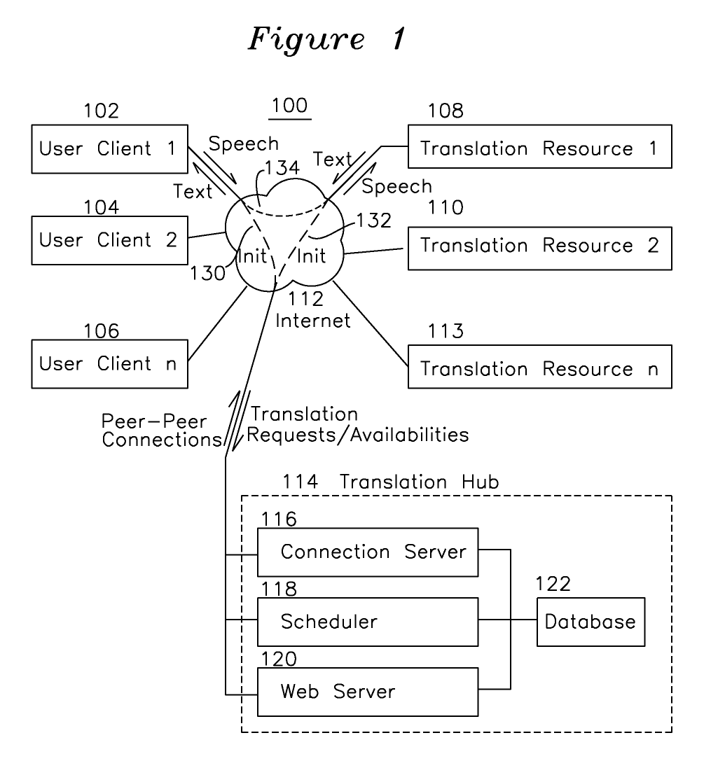

FIG. 1 shows a translation system which includes a plurality of requesting clients 102, 104, 106, a plurality of human translation resource clients 108, 110, 113. The translation resource clients 108, 110, 113 are user interfaces for human translators, suitable for receiving audible speech and generating text translations of the speech, or the translation resource clients may be any interface suitable for a person receiving speech input, performing a translation, and producing text output. A translation hub 114 is interconnected by a plurality of flexible network connections 112 which provides routing for connection requests originating or terminating in systems connected to the network 112. The translation hub 114 includes a connection server 116, a scheduler 118, and a web server 120, all of which are coupled to each other and to a database 122. In one embodiment of the invention, the plurality of human translation resource clients 108, 110, 113 provide a user interface to a human translator and accept speech input and produce text output using computers executing a client program which accepts speech input and converts the speech into packets containing the speech, using a protocol such as UDP or IP for transmission to a remote system via the internet, and can also display text which is received from a remote system such as a translation resource 108 or translation hub 114. The user client 102, 104, 106 can be realized using a special purpose computer having a speech input and text output under the control of operating software, and translation resource client 108, 110, 113 may also be realized using a special purpose computer having an audio speech output speaker or headphone jack, and a keyboard for typed data input and display for data verification and other communications. Alternatively, each user client 102, 104, 106 and translation resource client 108, 110, 113 may be a common hardware platform utilized by either user clients or translation resources, and comprise a general purpose computer coupled to a suitable keyboard for text entry, a text display for text output, a microphone for speech input, and a speaker for speech output, each device enabled or disabled as required by each particular user client and translation resource client, with the general purpose computer executing a program which is sensitive to whether it is operating in a user client 102 mode or a translation resource 108 mode. The translations performed by the translation resource clients 108, 110, 113, etc may be from speech of one language to text of another language such as in a language translation context, or speech of one language to text of the same language, referred to as “direct transcription”.

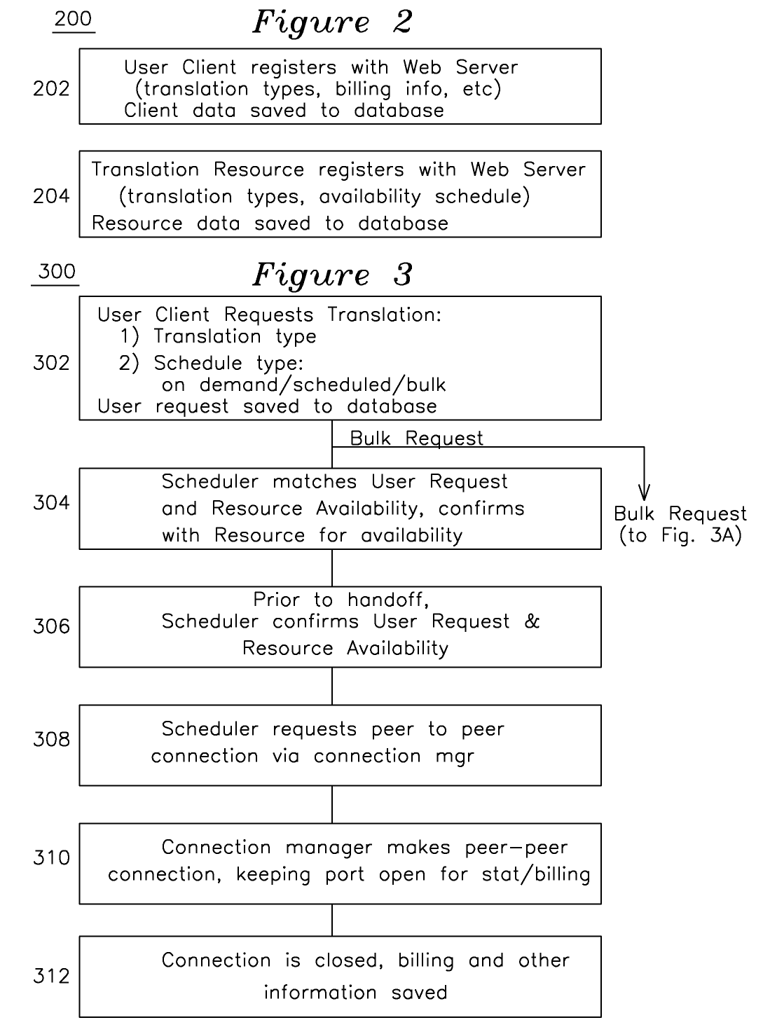

FIG. 2 shows a process flow for the initial registration of requesters and translation resources for the translation system of FIG. 1. Requester registration process 202 and translation resource registration process 204 form the registration processes 200. The translation requester registration process 202 includes steps such as registering the types of translations likely to be requested, generic registration information such as contact and billing information, and any other information related to a system user registration. Translation resource registration process 204 includes a registration of translation types and timeslot availability, including any other information such as billing rates, availability for on-demand translations, and the like. Two additional characteristics of a translation resource are attributes and capabilities. Attributes are assigned to the translation resource and are either global or translation (speech to text pair) specific. Examples of global attributes are geographic location, defaults such as billing rate, and other translation independent features. These global attributes are supplemented by language specific attributes, such as special billing rates for specific language combinations, and also includes ratings provided by previous requesters, which may be stored individually and with related comments for use by a future requester, or as a single value computed from previous translation events to form a metric for selection of a translation resource. Augmenting attributes are translation-specific capabilities, which in the present invention are understood to include special certifications for specific language combinations, such as legal or medical certifications, or any other capability that may be of interest to a requester or to the system satisfying a request.

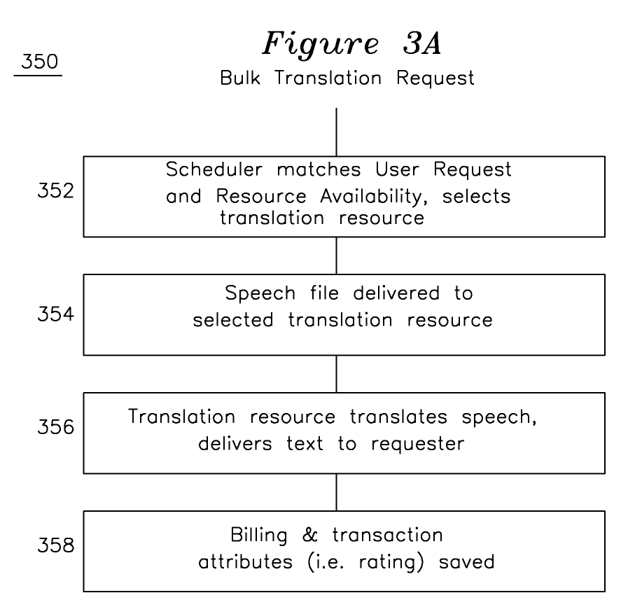

FIG. 3 shows a process flow 300 for the translation system of FIG. 1, directed to the handling of a translation request from a client. The process initiates with a user requesting a translation in step 302, where the request typically includes a translation matrix or speech to text pair such as the (input) spoken language and (output) text language for the desired translation, the type of translation (on-demand, scheduled, or bulk mode), and any other request information. The translation request is saved to a database for current (on-demand) or future (scheduled or bulk) processing. Bulk requests for translation of completed speech files are directed to the process of FIG. 3A.

For on-demand and scheduled translation requests, step 304 is performed by the scheduler such as 118 of FIG. 1, where the scheduler maps the translation request to a suitable translation resource based on the capabilities and attributes described earlier. Capabilities are used to form a pool of possible translation resource candidates based on hard requirements, while attributes are used to form selection criteria from among the pool of alternatives. For an on-demand request, step 304 is performed for each translation resource that are currently online, and a list of such on-demand resources is made by the scheduler 118 of FIG. 1 based on statistics and registration availability, and after a timeout on the order of a few seconds for each translation resource, a new translation resource is attempted until a confirmation occurs, thereby starting an on-demand translation connection between the requester and translation resource.

Following request 302 and requester and resource match 304 at a scheduled time appointment, final confirmation step 306 is an optional step which may be performed prior to the translation event. In one embodiment of the invention for scheduled translations, availability confirmations as shown in steps 304 and 306 are performed by having the translation resource agent 108 and the user client 102 each leave a TCP connection open to the connection server 116 of FIG. 1, where the schedule server uses these connections to send confirmations or reminders for the translation request prior to the scheduled time. In another embodiment of the invention for scheduled translations, steps 304 and 306 are performed by the scheduler based on the user client and translation resource sending a periodic UDP or TCP “hello” packet to the schedule server, each “hello” packet separated by a wait interval.

The same periodic hello packet transmission mechanism may be used to confirm availability of the translation resource agent for an on-demand translation, with the additional feature that the interval between the periodic hello packets may indicate availability of the translation resource, such that if there are many translation resources available, the wait interval between hello packets is long, and if there are comparatively few translation resources available, the wait interval between hello packets is comparatively shorter. There are many different methods to confirm availability of a user client 102 and a translation resource agent 108, and these examples are given only to aid in understanding the invention. Additionally, there are many different methods for using packets to indicate availability of the user client or the translation resource client. For example, it is generally desired for the client such as 102 or 108 of FIG. 1 to initiate an outgoing TCP connection or send a UDP packet to a server in hub 114 of FIG. 1 to avoid an infrastructure firewall (not shown) which would typically prevent the termination of an incoming connection to a client such as 102 or 108 of FIG. 1. To avoid the incoming connection to a firewall router problem, each client such as 102 and 108 may initiate a TCP connection to connection server 116, or send UDP packets with special port numbers or packet header information to perform the acknowledgment function described herein. Once a TCP connection is initiated from each client to the connection server, these initial connections may be used for communications including availability acknowledgments from the server to the client.

Upon final confirmation, and shortly prior to the scheduled connection, the requesting user client such as 102 of FIG. 1 is connected to a selected translation resource shown as resource 1 108 of FIG. 1. The connection is initially handled by the connection server 116 of FIG. 1, after which the connection is optionally migrated to a peer to peer connection directly from a translation requester to a translation resource in step 310, and the original connection may remain open to handle statistics information, billing information, and optionally to redirect the connection through the connection server if the performance of the peer to peer connection is inferior to the connection through the connection server. When the translation session is completed, the connections are closed in step 312, and billing or any other information related to the event are saved in the connection database.

FIG. 3A describes the handling of a bulk translation request, whereby the scheduler matches the user translation request with resource availability and capability and makes a translation resource selection in step 352, after which the translation resource may retrieve the speech file in step 354 by initiating a connection to one of the servers of hub 115 of FIG. 1 and subsequently retrieve the file from the database 122. Alternatively, the scheduler may deliver the file to the selected translation resource for translation in step 354. In step 356, the human translation resource translates the speech file retrieved by the translation resource client, and delivers the translated text to one of the servers in the translation hub 114, which stores the text file in the database 122 of FIG. 1. In step 358, billing and transaction attributes such as translation resource rating by the requester are stored in the database. For bulk translations, the speech file is stored in the database, and after translation, the text file may be saved to the database for instantaneous or future delivery to the requester.

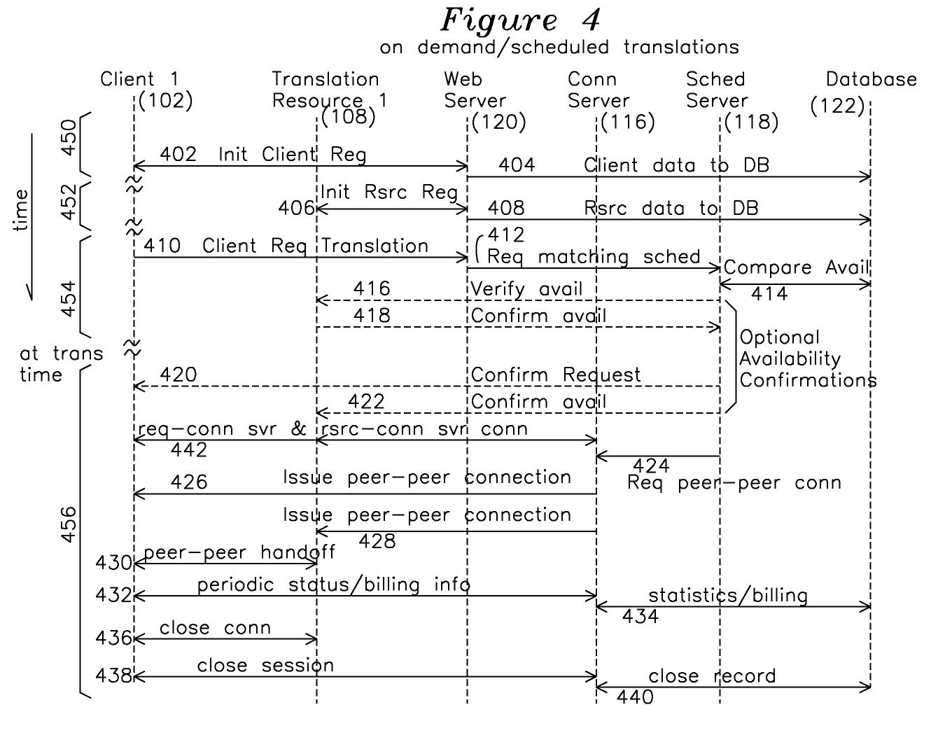

FIG. 4 shows the time sequence for the scheduled or on-demand translation events as described in the previous figures. Steps 450 correspond to the client registration process, whereby the client initially registers through a web server, which subsequently saves the transaction information in the database. The analogous sequence whereby a translation resource initially registers is shown in steps 452, and include the initial resource registration step 406 after which the translation resource capability information is saved to the database in step 408. The sequence relating to a translation request is shown in steps 454, whereby a translation requester makes a request 410 through a web server 120 or through a client program running on a computer or PDA which interfaces directly to the connection server 120 and database 122, after which the request is referred to a schedule server which searches the database to match the request with available translation resources in steps 412 and 414.

Following the identification of one or more matches in step 414, an optional verification of availability 416 to the translation resource may occur and be acknowledged 418 as shown in the dashed lines for the optional transaction steps of FIG. 4, which may optionally be performed using an existing TCP connection from the translation resource 108 to the schedule server 118, or the translation resource 108 may simply indicate availability by sending periodic UDP or TCP packets as described earlier. The verification 416 and acknowledgment 418 are optional steps which may be related to the time duration from request 410 to final confirmation 420/422 at periodic intervals preceding the start of the translation session 456. If the acknowledgment 418 is not made within an acknowledgment time interval, or the translation resource availability is denied by the translator, a new verification step 416 and acknowledgment 418 are attempted with a new translation resource matching the criteria.

Steps 456 show the events associated with either an on-demand translation request, or a scheduled translation request. The scheduler optionally confirms with the client 102 in step 420 and with the translation resource 108 in step 422, such as by using existing TCP connections with each, or through receipt of UDP or TCP “hello” packets from the respective clients as described earlier. In step 442, a connection from translation resource client 108 and user client 102 is either made through the connection server 116 as shown in steps 442, or through a peer to peer connection in steps 424, 426, 428 followed by a peer-peer handoff 430. The original connection is left open 432 for the purposes of collecting statistics and saving billing information 434. At the end of the translation session, the connection is closed 436 and the session is ended 438, including the recording of final billing information 440.

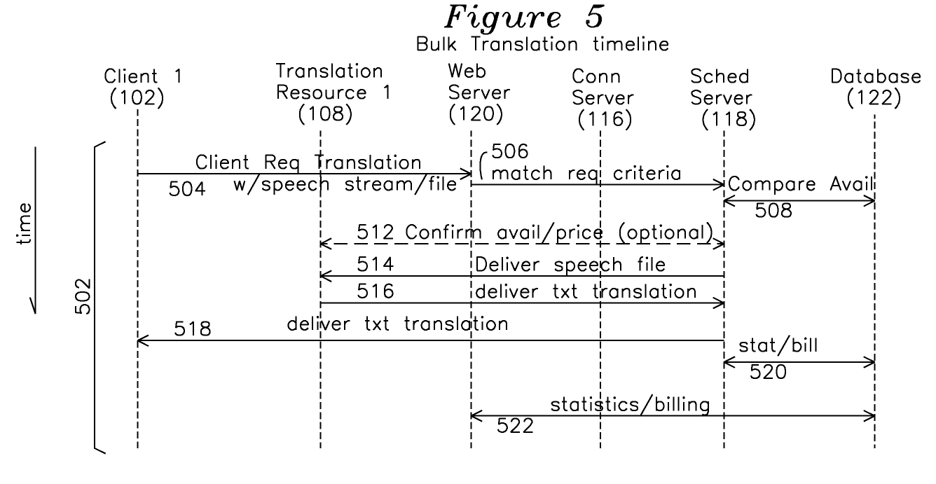

FIG. 5 shows the sequence of events for a bulk translation, whereby the user presents 504 either a single speech file for translation, or a continuous stream of speech which optionally may be divided into a plurality of parts, each part having a duration no greater than a pre-defined limit such as 2 minutes, to be translated or directly converted to one or more text files. The web server matches the request 506 with a translation resource in step 508, and the scheduler optionally performs a confirmation and acceptance of availability and price 512 with the selected translation resource, selecting an alternate translation resource if required. The request 504 is shown as presented to a web server, for example by using a web server using HTTP (Hyper Text Transfer Protocol) and a client responsive to HTML (Hyper Text Markup Language), or alternatively, the client may contain a program which presents a user interface to the operator, and interfaces directly to the connection server 116 and database 122 in the manner set forth as described in the embodiments of the invention. The schedule server 118 delivers 514 the speech file such as through a request by translation resource 108 via a TCP or UDP connection. The translated text file is subsequently provided 516, after which the schedule server 118 makes it available 518 to the client 102 such as by client request, or by contacting the requester using preferences as listed in the original request, or as expressed during the original registration. Statistics and billing information is provided 520 to the database 122 for future viewing 522 by the client.

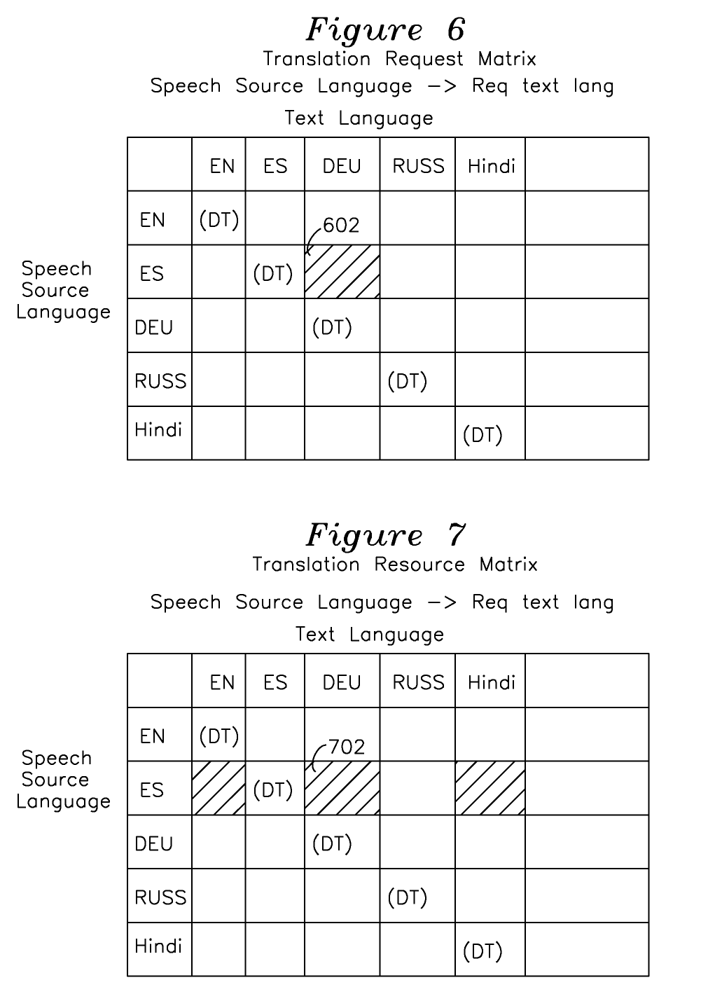

FIG. 6 shows a translation request matrix, whereby a user indicates the source speech language and desired text language, such as Spanish speech to German text pair shown as matrix entry 602. Direct transcription (DT) indicates the case where the source language and text language are identical.

FIG. 7 shows a translation resource matrix indicating translation capabilities. When a translation request arrives with a request matrix as shown in FIG. 6, the request is correlated with the capability matrix of FIG. 7 for each translation resource, and matching translation resources are used in conjunction with an availability schedule (not shown) in the confirmation process of step 414 of FIG. 4. Additionally, each entry of the translation resource matrix such as 702 may contain various additional attributes related to a particular speech source language/text language combination. For example, the Spanish source speech to German text translation capability entry 702 may also contain information such as the quality of translation, accuracy, or other attributes accumulated from requester evaluations of previous translation transactions.

FIG. 8 shows additional detail for a single translation resource capability entry such as 702 of FIG. 7. In addition to indicating translation ability from one speech language to the same or different text language, the matrix entry also includes details for this particular speech to text conversion, comprising one or more entry specific attributes 802 and also one or more entry specific capabilities 804. Entry specific attributes may include previous review ratings or comments 806, 808, 810 which may be of use to a future requester or to the selection algorithm of the scheduler for selecting between competing translation resources, and other attributes may be related to billing rates for certain language-specific or certificate-specific capabilities which are requested. The entry specific capabilities 804 include special capabilities specific to the speech-text pair such as legal or medical certifications for specialized translations requiring such certifications. Operating independent of specific speech-text combinations are general translator attributes 850, which may include translator location, education, overall review information, default billing rate, or any other general attributes which are not specific to a particular speech-text pairing found in the translation resource matrix of FIG. 7.

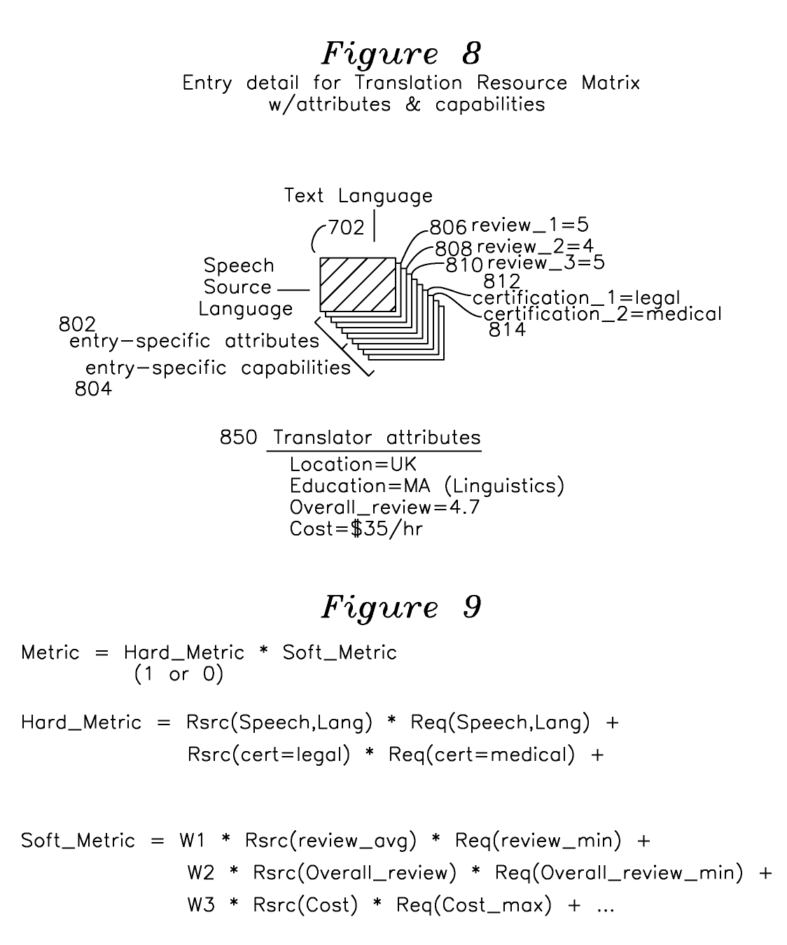

FIG. 9 shows the generation of a metric value which may be used to select a particular translation resource, where the metric value is derived from a Hard_Metric and a Soft_Metric. The Hard_Metric operates on, and generates binary values of 1 or 0, such that all conditions of the original request must be met before any additional evaluation of a particular translation resource is considered. For example, the Req(Speech,Lang) request 602 of FIG. 6 must be matched with an entry for the same combination Rsrc(Speech,Lang) such as 702 of FIG. 7, and any additional required capabilities such as legal certification and medical certification must also be met. Once a pool of potential translation resources satisfying these basic requirements is formed, this may be further qualified by the Soft_Metric, which generates a numerical value proportionate to criteria identified as important to the requester or system using a plurality of weight values W1 . . . Wn, each of which are multiplied by corresponding requester and resource criteria such as a resource review_avg and a requester review_min parameter indicating a minimum level of reviewer rating, or other criteria such as resource cost and requester maximum cost. By selecting the values for weighting factors and selection criteria, it is possible to form a soft metric which ranks the available resources according to requester criteria.

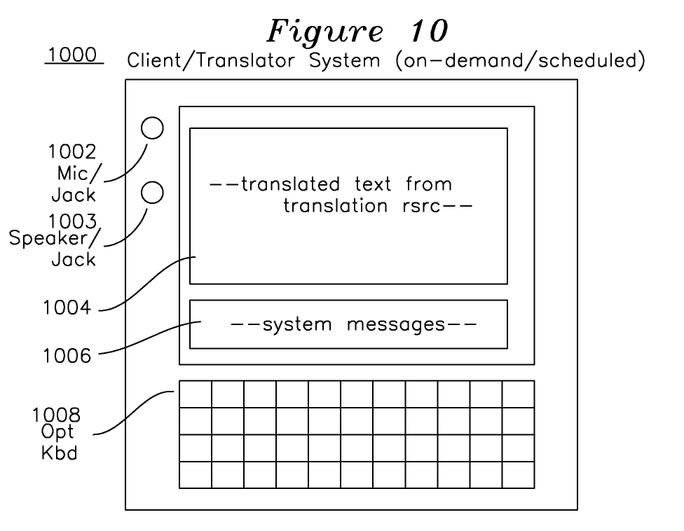

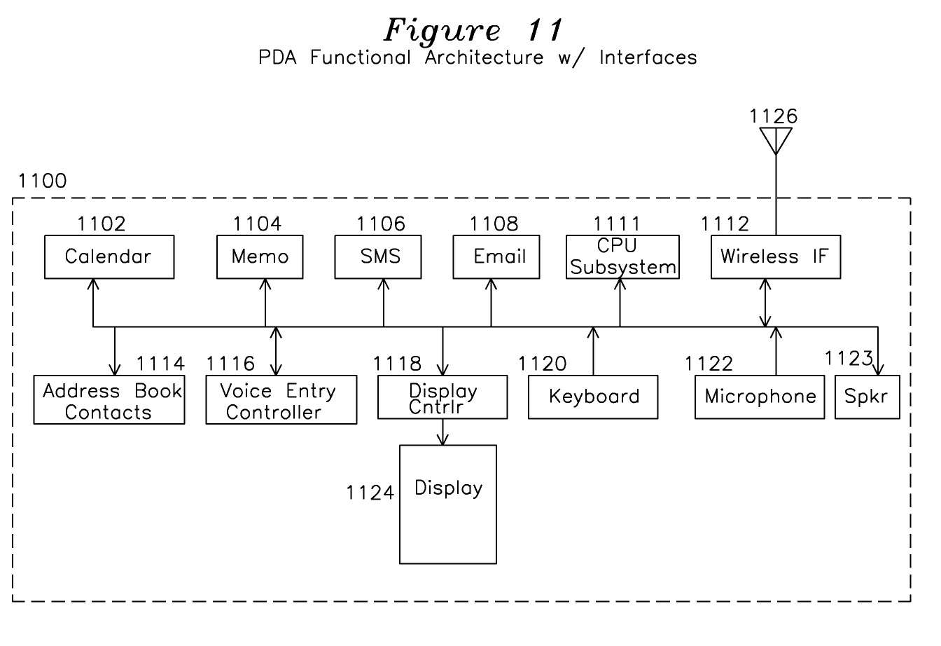

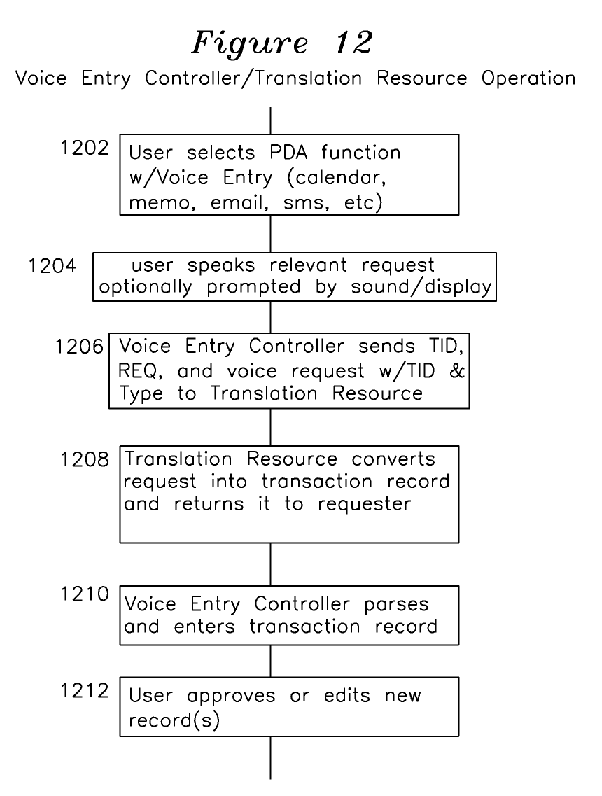

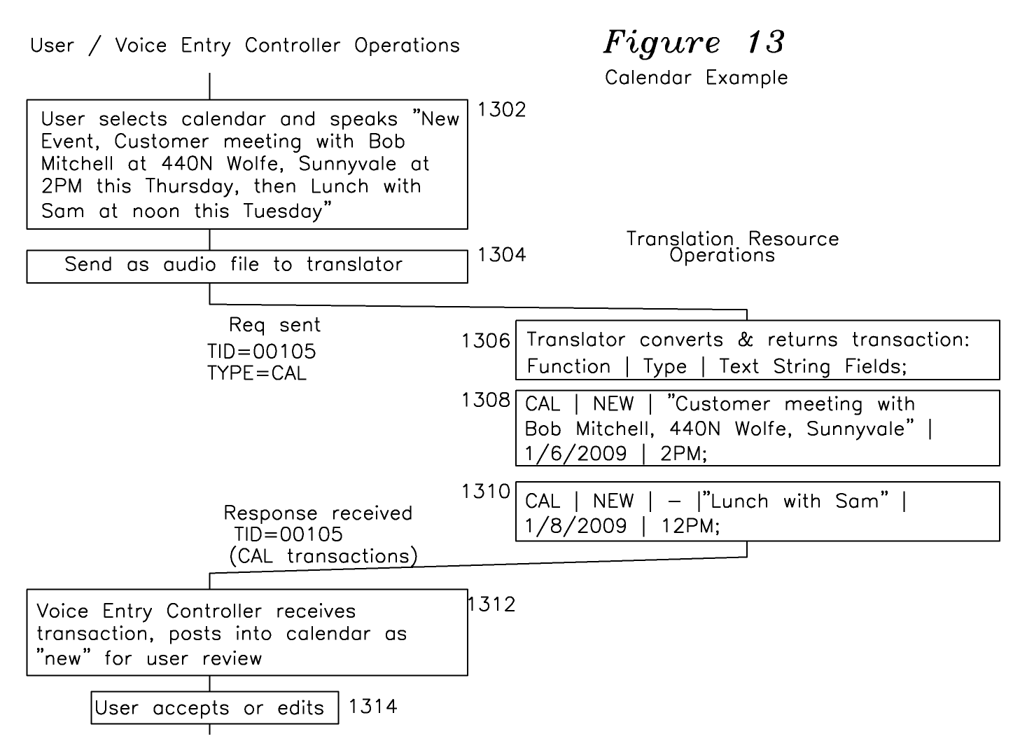

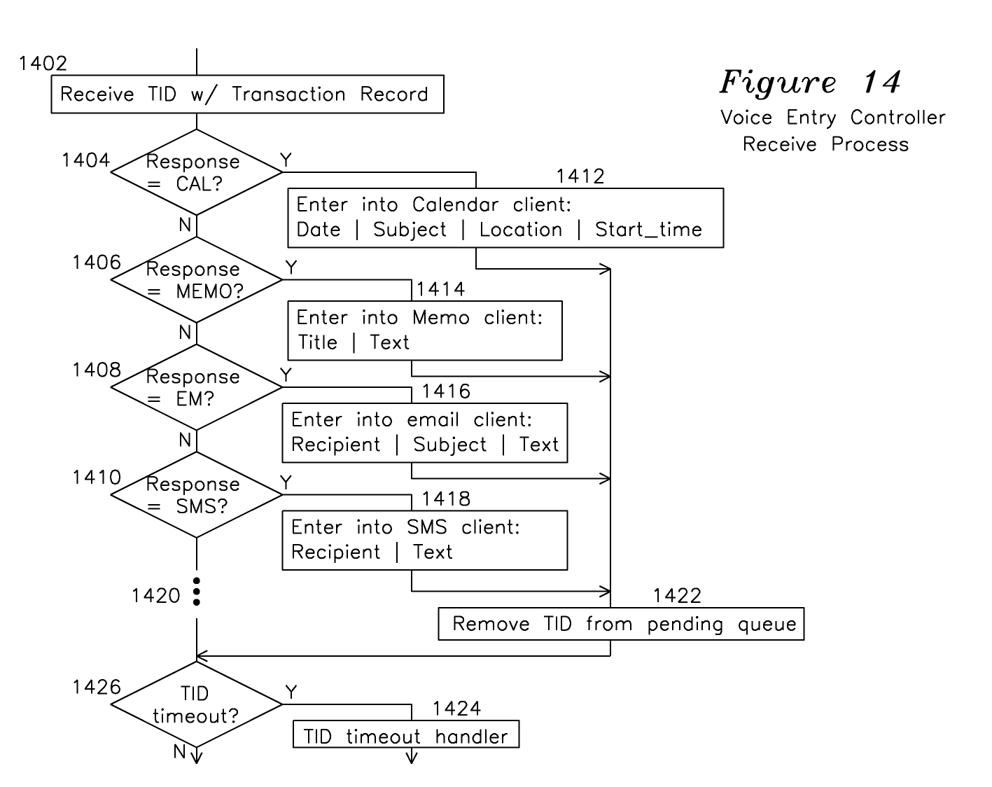

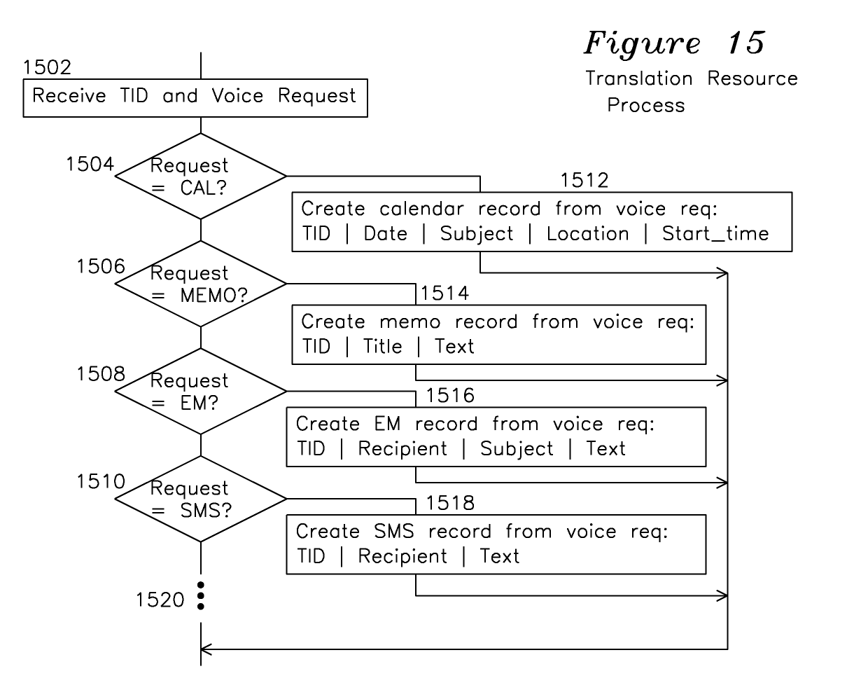

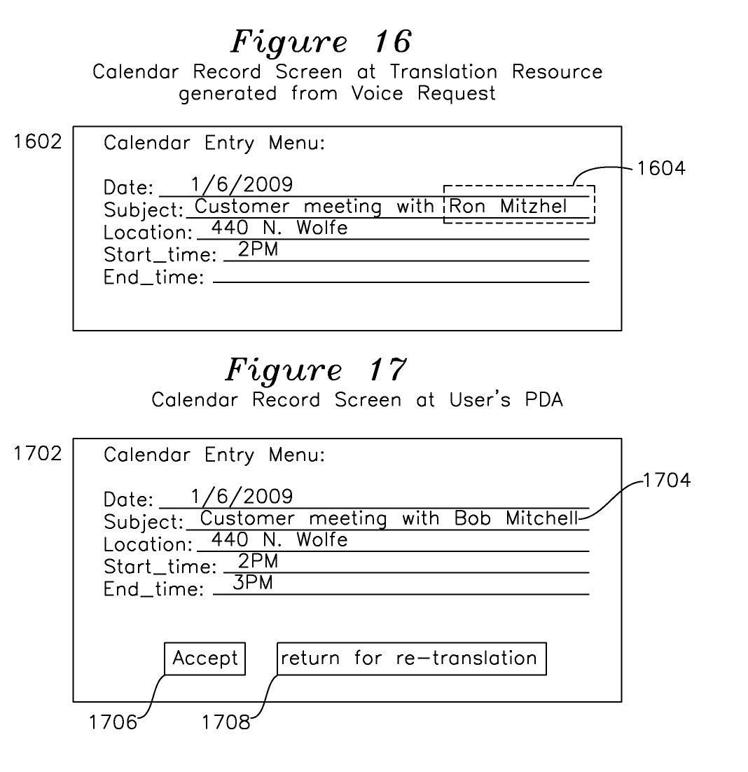

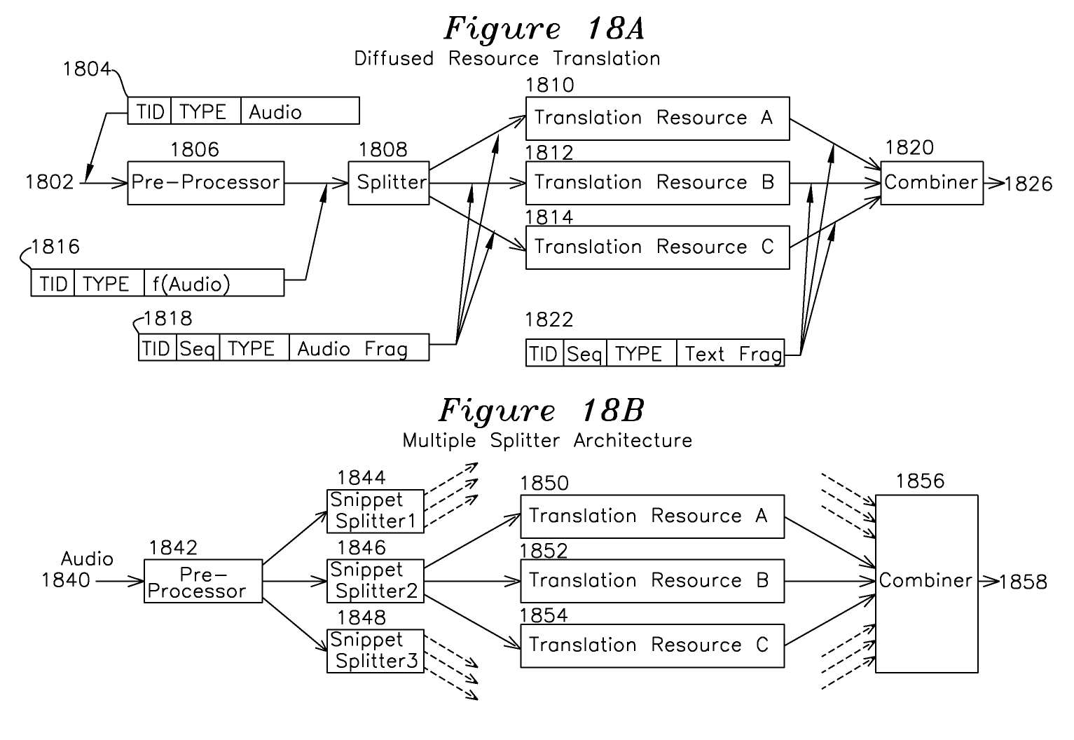

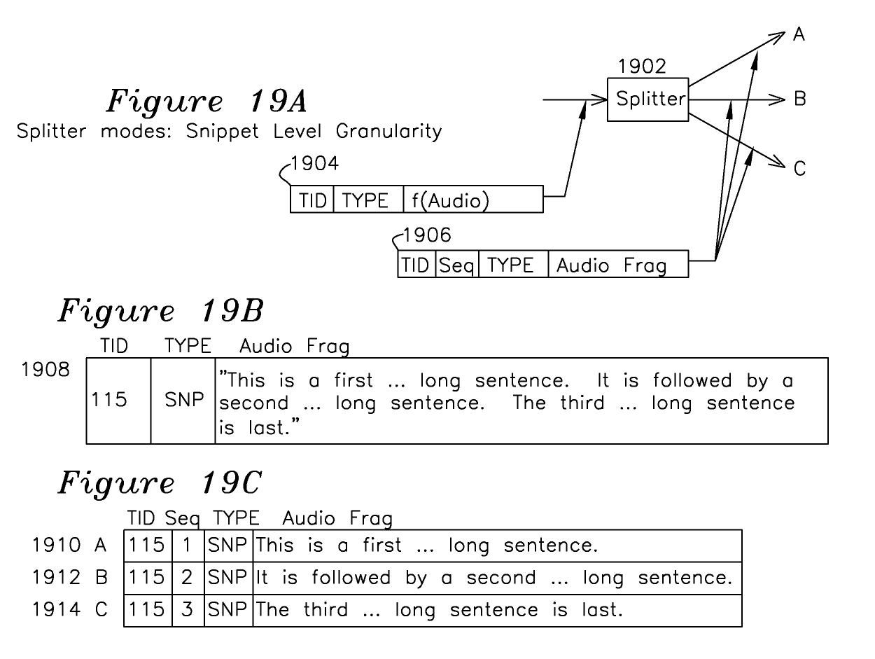

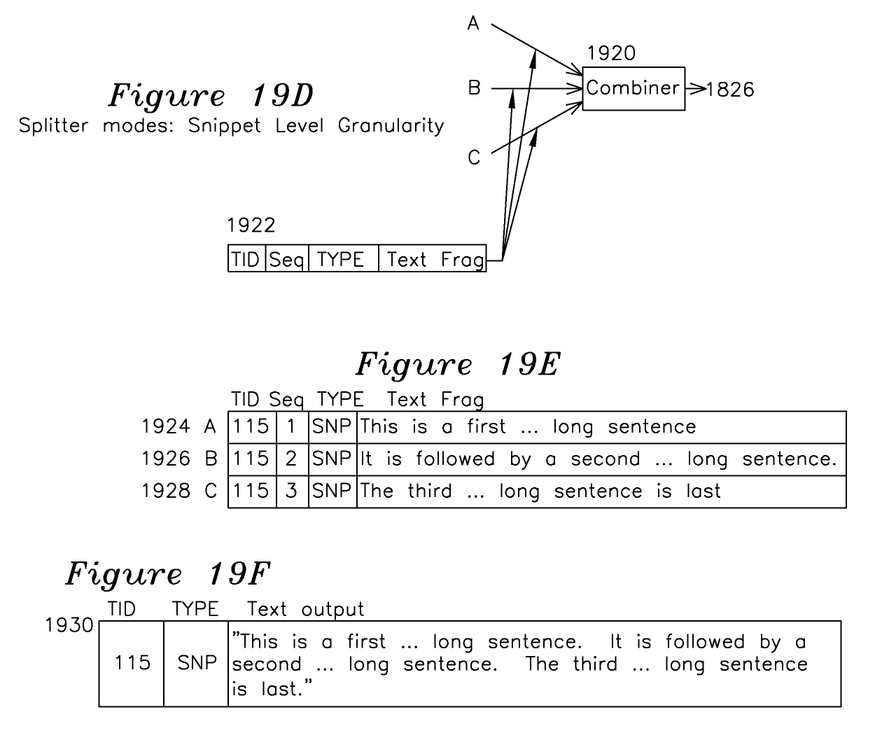

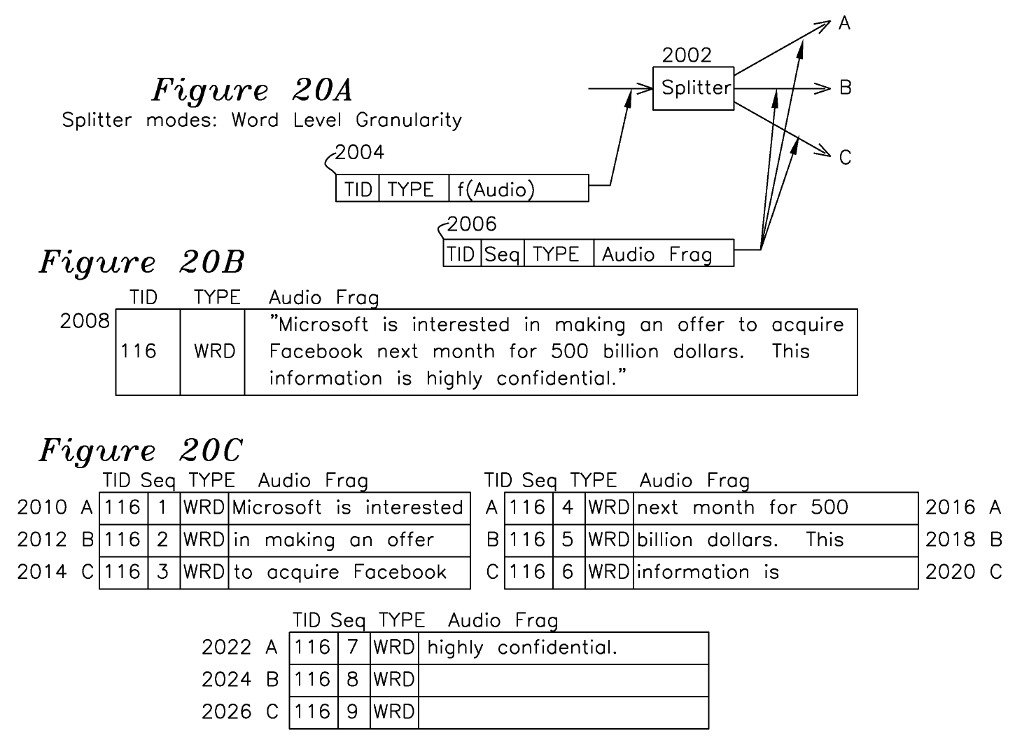

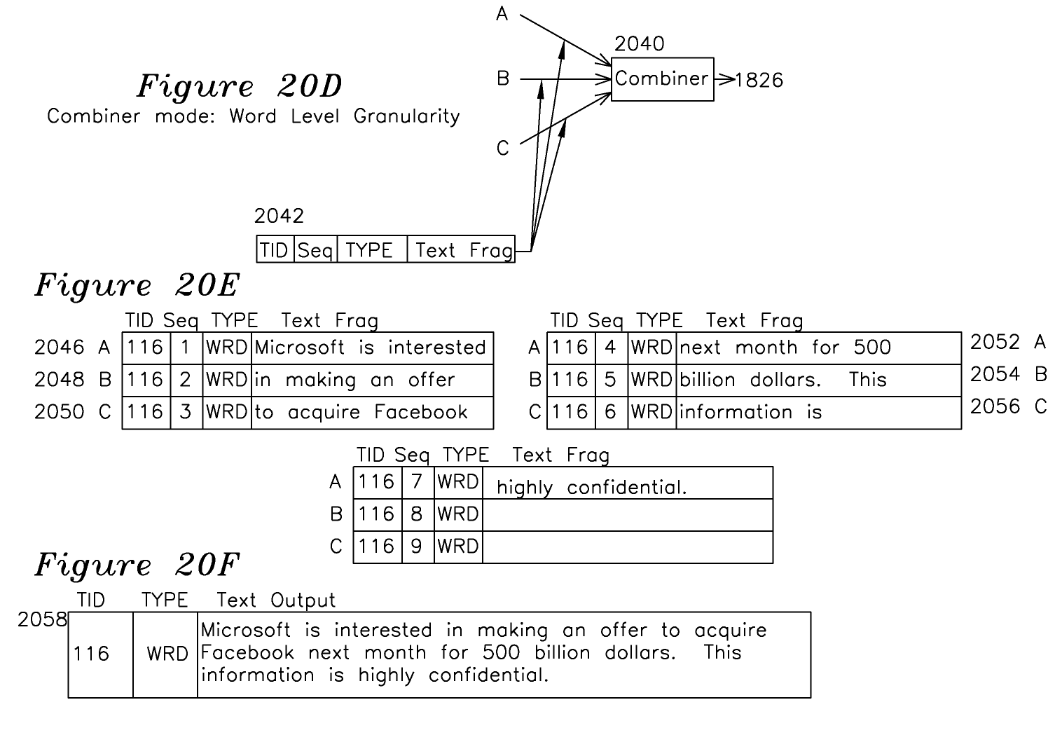

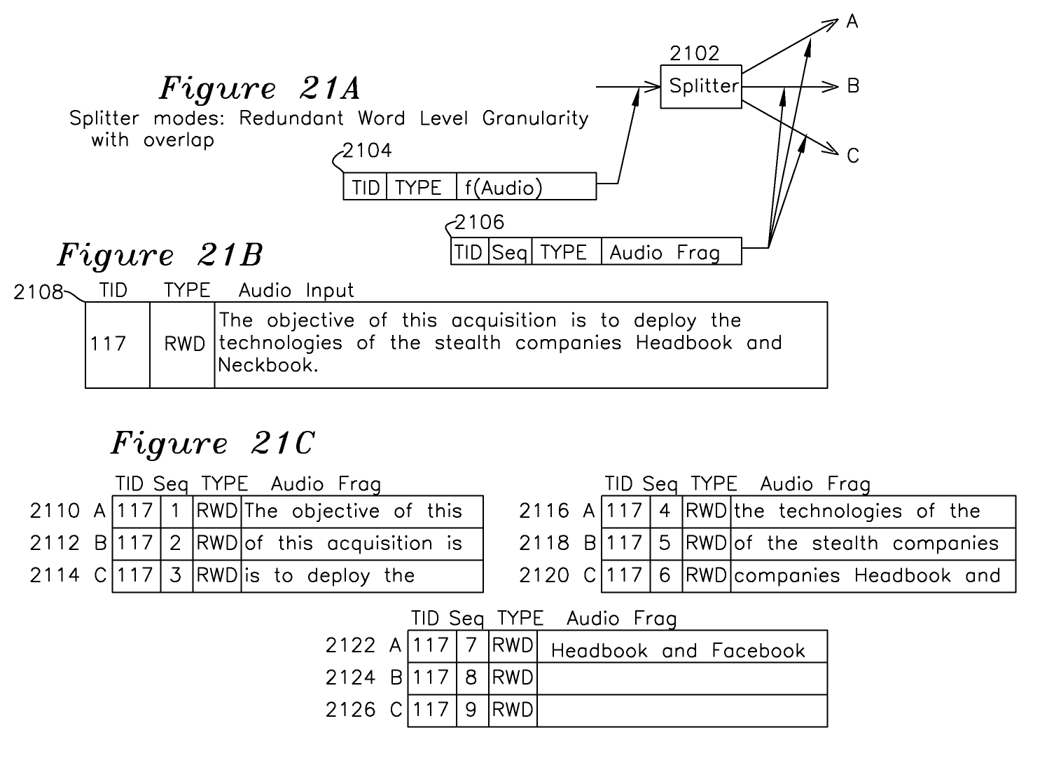

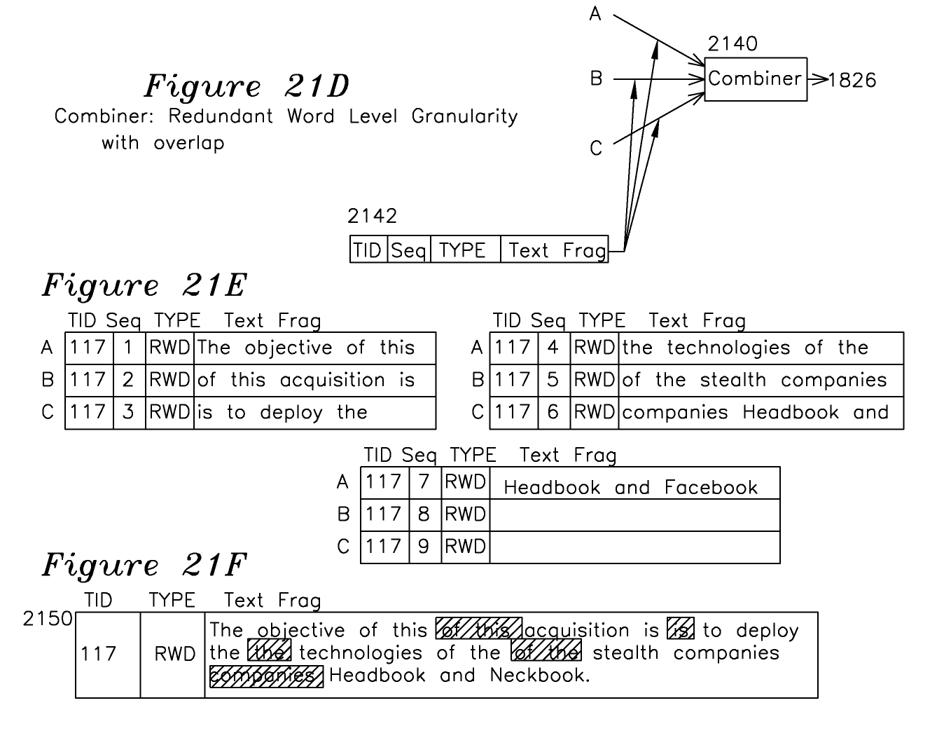

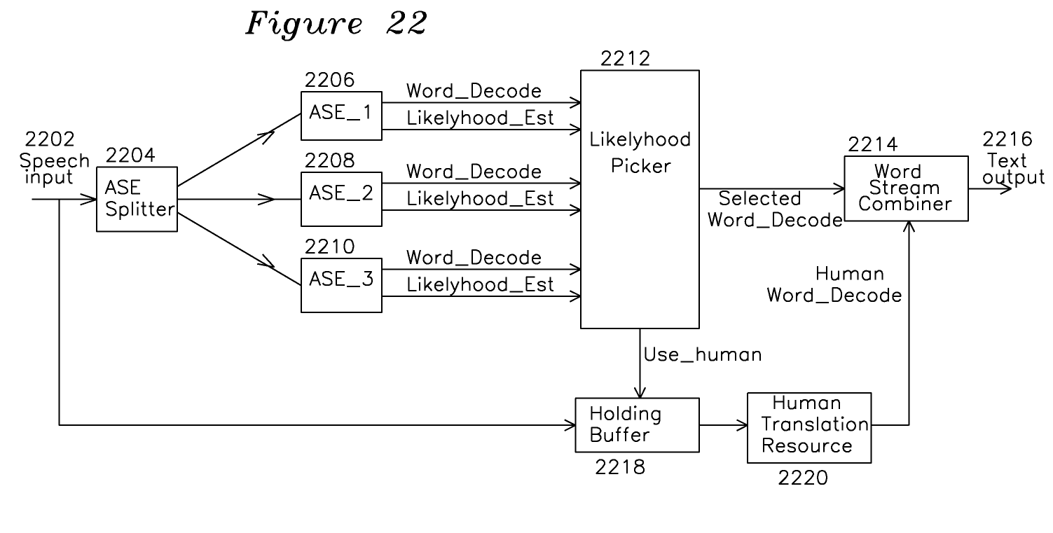

FIG. 10 shows one embodiment of a generalized user interface for the invention, either as a stand-alone device or as an application program for a general purpose computer. A requesters system or interface includes a microphone or microphone jack 1002 for speech input, a main screen 1004 for viewing translated text, optional screen 1006 for system messages, and optionally a keyboard 1008 for command input, or alternatively command input may be implemented through touch-screen buttons on screen 1004 and the like as known in the prior art of operator interfaces. The arrangement, size, and appearance of the features of FIG. 10 may also be context dependent. For example, in bulk mode, when the requester is speaking into the microphone or otherwise providing audio to input 1002, the translated text region 1004 may be minimized or deleted. Alternatively, the text region 1004 may have one part which is for translated text, and another part for a 3rd party client application, such as a web browser, a Customer Relation Management (CRM) portal, or any application suitable for cutting and pasting translated text from one part of a translated text screen 1004 into a 3rd party application part of the screen. The User Client may further process that text to enhance the value of an application. For example, that converted text may be placed in appropriate fields of an enterprise-wide information management system, such as the Customer Relationship Management systems offered by vendors such as Salesforce.com, SAP, Oracle, FrontRange, and Sage. Alternatively, where the application shown in FIG. 10 is executing on a mobile handheld computer, the converted text may be delivered to a program running in the background. In another alternative embodiment, upon receipt of the translated text, the client system 1000 may have a background process which accepts and sends the translated text as an email. In another alternative embodiment, the entire user client process may be implemented as a “plugin” module to an email client program like Microsoft Outlook, or Motorola Good Technology GoodLink.

A translation resource system or interface could include a speaker or headphone jack 1003, a keyboard 1008 for typing text as translated, a screen 1004 for viewing and optionally correcting translations, and an optional screen 1006 for system messages.

It is understood that the embodiments shown and described are for illustration only, and are not intended to limit the invention to only the specific embodiments disclosed herein. For example, the operator interface described herein could be practiced as an applications program for a tablet PC, cellular telephone, or any portable communications device having a speech input and text output, or a speech output and text input. Many aspects of the invention could be practiced different ways. In bulk mode, the speech could be sent as time-limited packets for translation by a single or multiple translation resources for the purpose of evaluating various translators before committing to a single translation resource, or the speech could be contained in a large single speech file. The translated text could be sent to the requester as an email, an email attachment, an instant message, a cell phone SMS message, or any text messaging protocol known in the prior art. While the present invention is described using the Internet protocol with IP packets, it may also be used with an Internet instant messaging protocol, text messaging over a voice or digital telephone service, a wireless transmission protocol including any of the family of IEEE 802.11 protocols, or a wireless cellular broadband data protocol such as Verizon EVDO, all of which are known in the communication arts.

1-18. (canceled)

19. A diffused resource translator having:
a pre-processor accepting a digitized audio message, the pre-processor generating one or more digitized audio fragments from said digitized audio message;
a plurality of splitters, each said splitter accepting said digitized audio fragments from said pre-processor, each said splitter generating an audio packet containing at least a transaction identifier (TID), a sequence number, a type field, and an audio sub-fragment generated from said digitized audio fragment with said audio sub-fragment sequence identified by said sequence number;
a plurality of translation resources, each said translation resource accepting said audio packet and generating a digital packet containing a respective said transaction identifier, said sequence number, said type field, and a text fragment associated with a corresponding audio sub-fragment;
a combiner accepting said digital packets and forming a text output for each transaction identifier by associating with each said transaction identifier the sequence of text fragments for said transaction identifier, said concatenation performed sequentially using said sequence number.

20. The diffused resource translator of claim 19 where at least one said preprocessor or splitter accepts said digitized audio message and generates said audio packets, where said audio sub-fragment contains less than 30 words from said digitized audio message.

21. The diffused resource translator of claim 20 where each said audio packet contains a sequentially assigned sequence number, each said audio packet routed to a different translation resource than a preceding audio packet.

22. The diffused resource translator of claim 19 where each said translation resource receives said audio packet containing less than 5 words.

23. The diffused resource translator of claim 19 where at least one said translation resource receives said audio packet containing a single word.

24. The diffused resource translator of claim 19 where said splitter generates said audio packets with an overlap of at least one word and said combiner removes the duplicate overlap word or words.

25. The diffused resource translator of claim 19 where at least one said translation resource is an automated speech engine (ASE).

26. A portable communications system accepting audio messages for at least one of: address book contact, calendar event, memo, email, or text message, sending said audio messages to a translation resource, said translation resource converting said audio message into a transaction record and returning it to said portable communications system, said portable communications system thereafter entering said transaction record into the corresponding said address book contact, calendar event, memo, email or text message.

27. A translation system remote from a portable communications system, the translation system:
receiving from said portable communications system a voice request packet containing at least a request transaction identifier, an entry type, and digitized audio speech;
forming a transaction record containing a function field, a type field, and a text string field, said text string field containing at least a text string derived from said digitized audio speech;
sending said transaction record to said portable communications system generating an associated said voice request packet;
where said transaction record function field identifies at least one of: a calendar function, an address book function, a memo function, an email function, or a text message function.

28. A portable communications device having:
application functions, the application functions including at least one of: a calendar function, an address book function, a memo function, an email function, or a text message function, each said application function having associated local data residing in said portable communications device;
a voice entry controller for receiving voice commands associated with a selected said application function, the voice entry controller forming a voice request packet containing a transaction identifier, a transaction type which identifies a particular said application function, and a voice request audio file containing said voice command;
a wireless transmitter for sending said request packet to a remote system;
a wireless receiver for receiving response packets from a remote translation system;
said response packet from said remote translation system containing a transaction identifier associated with a previously sent request packet, said response packet having one or more text string fields containing instructions to either create a new entry or modify an existing entry associated with a particular application having data residing in said portable communications device.

29. A portable communications device having:
a wireless interface for communications to a remote system, the remote system having a splitter for receiving a digitized audio message, separating the digitized audio message into a plurality of audio packets, each containing a transaction identifier, sequence number type, and an audio sub-fragment formed from the digitized audio packet;
at least one application, said application responsive to keyboard commands to generate or modify records;
a voice interface for receiving voice commands, said voice commands provided to said remote system using said wireless interface, said remote system generating and returning said voice commands as transaction records to said portable communications system;
said transaction records handled by said voice interface to generate or modify records in the same manner as said keyboard.

30. A process for diffused translation having:
a first step of a splitter accepting a digitized audio message;
a second step of said splitter generating digitized audio fragments from said digitized audio message and thereby forming an audio packet containing at least an audio fragment, a transaction identifier, and a sequence number, said sequence number indicating the order of an audio fragment within said audio message;
a third step of said splitter assigning said audio packets to a plurality of translation resources for conversion to a digital packet containing a corresponding said transaction identifier, sequence number, and text fragment corresponding to the translation of said digitized audio fragment, each said translation resource operating independently from another said translation resource;
a fourth step of concatenating said digital packets using a combiner, said combiner separately operative on each particular said transaction identifier and concatenating said digital packets according to said sequence number, thereby forming a message for each said transaction identifier.

31. The process of claim 30 where said second step splitter audio fragment contains less than 30 words.

31. The process of claim 30 where said third step assigning said audio packets to a plurality of translation resources routes said audio packet to a different translation resource than a preceding audio packet.

32. The process of claim 30 where said third step assigning said audio packets are routed to a plurality of translation resources using a round robin translation resource assignment routing.

33. The process of claim 30 where said third step translation resource receives said audio packet containing less than 5 words.

34. The process of claim 30 where said third step translation resource receives said audio packet containing a single word.

35. The process of claim 30 where said third step splitter generates said audio packets with an overlap of at least one word and said fourth step combiner removes the duplicate overlap word or words.

36. The process of claim 30 where said third step translation resource is an automated speech engine.

37. The process of claim 30 where said second step splitter also performs speech pitch shifting when generating said audio fragment.
